(19) United States
(12) Patent Application Publication
(10) Pub. No.: US 2006/0106157 A1
(43) Pub. Date: May 18, 2006

(54) Urethane acrylate tie coats

(76) Inventors: Suresh G. Sawant, Stevenson Ranch, CA (US); Jak Haroutiun Aklian, North Hollywood, CA (US)

Correspondence Address: PPG Industries, Inc., Intellectual Property Department, One PPG Place, Pittsburgh, PA, 15272, US

(21) Appl. No.: 10/990,620

(22) Filed: Nov. 17, 2004

(51) Int. Cl. C08G 18/08

(52) U.S. Cl. 524/589

(57) ABSTRACT

Compositions comprising urethane acrylates for enhancing adhesion between coatings, methods of enhancing coating adhesion using a tie coat comprising urethane acrylates, multi-layer composite coatings comprising urethane acrylates, and methods of refinishing an aged coating are disclosed.

This disclosure relates to compositions comprising urethane acrylates for enhancing adhesion between coating layers, to methods of enhancing the coating adhesion using a tie coat comprising urethane acrylates, to methods of refinishing an aged coating, and to multi-layer coatings comprising urethane acrylates.

Multi-layer coatings are widely used in the aviation and aerospace industry. For example, an aviation and aerospace coating system can include an anticorrosive primer, a base coat, and a top coat. When multiple coatings are used, the integrity of the coating system can depend on the adhesion between adjoining coatings. It is therefore desirable that the multiple coatings exhibit excellent adhesion to adjoining coatings.

When a large surface such as that of an aircraft is to be refinished, it can be useful to apply a new coating, such as a top coat, directly over an aged coating. However, adhesion of certain coatings such as for example, polyurethane top coats, to aged coatings is generally poor. Surface phenomena of the aged coating, such as chalking, the presence of surface micropores, and entrapped water can contribute to the poor adhesion of new polyurethane top coats to an aged coating.

To facilitate and/or enhance adhesion to an aged coating, the aged coating can be mechanically abraded prior to applying the polyurethane top coat. Mechanical abrasion of an aged coating can be accomplished by, for example, sanding. Sanding large coated surfaces, such as those of an aircraft, can be costly, time consuming, and difficult to control to the extent necessary to facilitate uniform adhesion of a newly applied top coat. Furthermore, the process of mechanical abrasion can release particulates containing potentially harmful and/or toxic chemicals.

Adhesion of a polyurethane top coat to aged coatings can be enhanced by applying a tie coat between the aged coating and a subsequently applied top coat. Examples of such inter-coating tie coats comprising chlorinated polyolefins are disclosed in U.S. patent application Ser. No. 10/822,884 filed Jun. 30, 2004.

It is useful to provide further coating compositions which can be used to enhance the adhesion between aged coatings and a subsequently applied top coat as an alternative to mechanical abrasion.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth herein are approximations that can vary depending upon the desired properties to be obtained.

In this application, the use of the singular includes the plural unless specifically stated otherwise. In this application, the use of “or” means “and/or” unless stated otherwise. Furthermore, the use of the term “including,” as well as other forms, such as “includes” and “included,” is not limiting.

Tie coats for providing enhanced adhesion between adjoining coatings can comprise urethane acrylates formed from polyisocyanates having reactive isocyanate groups, and hydroxy-acrylics having hydroxyl groups reactive with the isocyanate groups. As used herein, the term “reactive” refers to a functional group, such as an isocyanate group and a hydroxyl group, which forms a covalent bond with another functional group under suitable reaction conditions.

Urethane acrylates of the present disclosure can be prepared by reacting at least one hydroxy-acrylic, with at least one polyisocyanate. An example of a reaction for forming a urethane acrylate and a cycloaliphatic polyisocyanate is shown in Scheme 1.

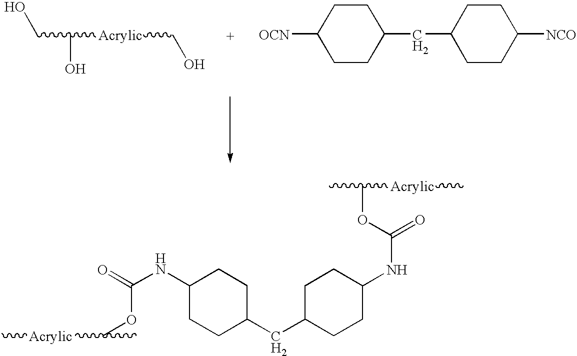

Hydroxy-acrylic polymers useful in coating compositions of the present disclosure can comprise terminal and/or pendent hydroxyl groups capable of reacting with isocyanate groups. A hydroxy-acrylic polymer includes hydroxyl functional groups that are incorporated into the polymer by including one or more hydroxyl functional monomers in the reactants used to produce the copolymer. A hydroxy-acrylic polymer can be a hydroxy-containing acrylic copolymer, e.g., an interpolymer of monoethylenically unsaturated hydroxy-containing monomers such as hydroxyalkyl acrylate or hydroxyalkyl methacrylate, and in certain embodiments such hydroxy-containing alkyl acrylates or methacrylates can have from 2 to 6 carbon atoms in an alkyl group, and other ethylenically unsaturated copolymerizable monomers such as alkyl acrylates and alkyl methacrylates. Examples of suitable hydroxyalkyl acrylates or hydroxyalkyl methacrylates include 2-hydroxyethyl acrylate, 2-hydroxy-1-methylethyl acrylate, 2-hydroxypropyl acrylate, 3-hydroxypropyl acrylate, 2-hydroxybutyl acrylate, 4-hydroxybutyl acrylate, 2-hydroxyethyl methacrylate, 2-hydroxy-1-methylethyl methacrylate, 2-hydroxypropyl methacrylate, 3-hydroxypropyl acrylate, 2-hydroxybutyl methacrylate, 4-hydroxybutyl methacrylate and the like, and acrylic acid or methacrylic acid esters of ethylene glycol and propylene glycol such as diethylene glycol acrylate, and the like. Also useful are hydroxy-containing esters and/or amides of unsaturated acids such as maleic acid, fumaric acid, itaconic acid, and the like. In certain embodiments, a suitable hydroxy-acrylic polymer includes from 5 percent to 35 percent by weight of monoethylenically unsaturated hydroxy-containing monomers based on total monomer weight, and in certain embodiments from 10 percent to 25 percent by weight. Examples of suitable alkyl acrylates and methacrylates include methyl acrylate, ethyl acrylate, propyl acrylate, isopropyl acrylate, butyl acrylate, isobutyl acrylate, hexyl acrylate, 2-ethylhexyl acrylate, nonyl acrylate, lauryl acrylate, stearyl acrylate, cyclohexyl acrylate, isodecyl acrylate, phenyl acrylate, isobomyl acrylate, methyl methacrylate, ethyl methacrylate, propyl methacrylate, isopropyl methacrylate, butyl methacrylate, isobutyl methacrylate, hexyl methacrylate, 2-ethylhexyl methacrylate, nonyl methacrylate, lauryl mlethacrylate, stearyl methacrylate, cyclohexyl methacrylate, isodecyl methacrylate, phenyl methacrylate, isobornyl methacrylate, and the like.

In certain embodiments, a hydroxy-acrylic polymer can be a modified hydroxy-acrylic copolymer. For example, after reaction of the various monomers to form a hydroxy-acrylic, the acrylic polyol can be modified by successive reactions that lengthen pendent hydroxyl groups. For example, a hydroxy-acrylic copolymer can be further reacted with a dicarboxylic acid anhydride under conditions that can generate pendent ester-carboxyl groups. A dicarboxylic acid anhydride, such as hexahydrophthalic anhydride and tetrahydrophthalic anhydride, can be reacted with a portion of the hydroxyl functionality on the hydroxy-acrylic, for example from 30 percent to 100 percent, and in certain embodiments, from 40 percent to 80 percent of the hydroxyl functionality. In certain embodiments, the anhydride can be tetrahydrophthalic anhydride. In certain embodiments, a carboxylic group on an anhydride-modified hydroxy-acrylic can subsequently be reacted with a monoepoxide functional monomer, for example, an epoxy ester. The epoxy ester can be, for example, a glycidyl ester mixture such as CARDURA E (commercially available from Shell Oil Company) that is a glycidyl ester of a tertiary inono-carboxylic acid blend having carbon chain lengths of from 9 to 11 carbon atoms. The epoxy ester can be reacted with the anhydride modified acrylic polyol in amounts sufficient to react with portions of the carboxylic acid groups, wherein such amounts can be from 1 percent to 25 percent by weight of the total weight of acrylic polyol, and in certain embodiments from 5 percent to 15 percent by weight.

Suitable hydroxy-acrylic polymers can also be prepared from polymerizable ethylenically unsaturated monomers and can be copolymers of (meth)acrylic acid or hydroxylalkyl esters of (meth)acrylic acid with one or more other polymerizable ethylenically unsaturated monomers such as alkyl esters of (meth)acrylic acid including methyl (meth)acrylate, ethyl (meth)acrylate, butyl (meth)acrylate and 2-ethyl hexylacrylate, and vinyl aromatic compounds such as styrene, alpha-methyl styrene, and vinyl toluene. As used herein, “(meth)acrylate” and like terms are intended to include both acrylates and methacrylates.

Acrylic polymers can also be prepared from ethylenically unsaturated, beta-hydroxy ester functional monomers. Such monomers can be derived from the reaction of ethylenically unsaturated acid functional monomers, such as monocarboxylic acids, for example, acrylic acid, and an epoxy compound that does not participate in the free radical initiated polymerization with the unsaturated acid monomer. Examples of such epoxy compounds include glycidyl ethers and esters. Examples of suitable glycidyl ethers include glycidyl ethers of alcohols and phenols such as butyl glycidyl ether, octyl glycidyl ether, phenyl glycidyl ether, and the like. Examples of suitable glycidyl esters include CARDURA E10, commercially available from Shell Chemical Company, and GLYDEXX-10, Exxon Chemical Company. In certain embodiments, beta-hydroxy ester functional monomers can be prepared from ethylenically unsaturated, epoxy functional monomers, for example glycidyl (meth)acrylate and allyl glycidyl ether, and saturated carboxylic acids such as a saturated monocarboxylic acid, for example, isostearic acid.

In certain embodiments, ethylenically unsaturated aromatic monomers used to synthesize a hydroxy-acrylic can be chosen from monomers such as styrene and alpha-methyl styrene, including substituted styrene or substituted alpha-methyl styrene where substitution is in the para position and is a linear or branched alkyl group having from 1 to 20 carbon atoms, for example, vinyl toluene, 4-vinylanisole, and 4-vinylbenzoic acid. Also, ethylenically unsaturated aromatic monomers can contain fused aryl rings. Examples include 9-vinylanthracene and 9-vinylcarbazole.

In certain embodiments, ethylenically unsaturated hydroxyl functional monomers used to synthesize a hydroxy-acrylic can be chosen from hydroxyalkyl acrylates and methacrylates, including, for example, hydroxyethyl acrylate, hydroxyethyl methacrylate, hydroxypropyl acrylate, hydroxypropyl methacrylate, hydroxybutyl acrylate, hydroxybutyl methacrylate, and mixtures thereof.

In addition to the alkyl acrylates and methacrylates, other ethylenically unsaturated copolymerizable monomers can be copolymerized with the hydroxyalkyl acrylates and methacrylates including such ethylenically unsaturated materials as mono-olefinic and di-olefinic hydrocarbons, halogenated mono-olefinic and di-olefinic hydrocarbons, nitriles, and the like. Examples of suitable monomers include styrene, alpha-methylstyrene, alpha-methyl chlorostyrene, 1,3-butadiene, acrylamide, acrylonitrile, methacrylonitrile, vinyl butyrate, vinyl acetate, allyl chloride, divinyl benzene, diallyl itaconate, and mixtures thereof. These other ethylenically unsaturated monomers can be used in a mixture with one or more of the above-mentioned alkyl acrylates and methacrylates. An acrylic copolymer can also include minor amounts, for example, from 1 percent to 10 percent by weight of an alpha, beta-ethylenically unsaturated carboxylic acid such as acrylic acid or methacrylic acid.

In certain embodiments, hydroxy-acrylics used to form coating compositions of the present disclosure can be a MACRYNAL monomer commercially available from UCB Additives. Other hydroxy-acrylics are commercially available from, for example, Dow Chemical as TONE monomers, from Lyondell as ACRYFLOW monomers, and from Degussa AG as RESINE LTW monomers.

Polyisocyanates useful for forming coating compositions of the present disclosure include aliphatic polyisocyanates, cycloaliphatic polyisocyanates, aromatic polyisocyanates, and mixtures thereof. Polyisocyanates of the present disclosure can comprise any organic-polyisocyanate that contains reactive isocyanate groups which are attached to aliphatic, cycloaliphatic, and/or aromatic structures. As used herein, the term “reactive isocyanate” refers to un-reacted isocyanate groups, i.e., —NCO groups, that are capable of reacting with active hydrogen groups, such as hydroxyl groups, to form linkages, such as urethane linkages, i.e., —NH—C(O)—O—. In certain embodiments, polyisocyanates can include those having from 2 to 5 isocyanate groups per molecule, and in certain embodiments, polyisocyanates comprise diisocyanates having 2 isocyanate groups per molecule. Cycloaliphatic polyisocyanates can be useful in enhancing the UV stability of a cured coating composition.

In certain embodiments, a polyisocyanate comprises an aliphatic diisocyanate, a cycloaliphatic diisocyanate, or mixtures thereof. Examples of useful aliphatic diisocyanates include 1,4-tetramethylene diisocyanate, 1,6-hexamethylene diisocyanate, trimethylene diisocyanate, tetramethylene diisocyanate, tetramethylxylylene diisocyanate, pentamethylene diisocyanate, hexamethylene diisocyanate, 1,2-propylene diisocyanate, 1,2-butylene diisocyanate, 2,3-butylene diisocyanate, 1,3-butylene diisocyanate, 1,2-ethylene diisocyanate, 1,4-tetramethylene diisocyanate, 1,6-hexamethylene diisocyanate, 2,2,4- or 2,4,4-trimethyl- 1,6-hexamethylene diisocyanate, 1,12-dodecane diisocyanate, 3′-diisocyanato-dipropyl ether, and the like. In certain embodiments, an aliphatic diisocyanate is 1,6 hexamethylene diisocyanate. Suitable aliphatic diisocyanates are commercially available, for example, as TOLONATE monomers from Rhodia PPMC, such as TOLONATE HDT-90.

Examples of useful aromatic diisocyanates include 4,4′-diphenylmethane diisocyanate, 1,3-phenylene diisocyanate, and toluene diisocyanate. Suitable aromatic diisocyanates are commercially available, for example, as MONDUR monomers from Bayer USA, Inc.

Examples of useful cycloaliphatic diisocyanates include 1,1′-methylene bis (4-isocyanatocyclohexane), α,α-xylylene diisocyanate, 1-isocyanato-3,3,5-trimethyl-5-isocyanatomethyl-cyclohexane (isophorone diisocyanate), 1,3- and 1,4-cyclohexane diisocyanate, and 4,4′-diisocyanatodicyclohexyl-methane, cyclobutane 1,3-diisocyanate, 2,2-and 2,6-diisocyanato- 1-methyl-cyclohexane, 2,5- and 3,5-bis(isocyanatomethyl)-8-methyl-1,4-methano-decahydro-naphthalene, 1,5-, 2,5-, 1,6- and 2,6-bis(isocyanatomethyl)-4,7-methanohexahydroindane, 1,5-, 2,5-, 1,6- and 2,6-bis(isocyanato)-4,7-methanohexahydroindane, dicyclo-hexyl 2,4′- and 4,4′-diisocyanate, and the like. In certain embodiments, a cycloaliphatic diisocyanate is dicyclohexylmethane diisocyanate. Suitable cycloaliphatic diisocyanates are commercially available, for example, as DESMODUR monomers from Bayer USA, Inc.

These and other suitable polyisocyanates are described in more detail in U.S. Pat. No. 4,046,729 at column 5, line 26 to column 6, line 28, incorporated herein by reference.

Urethane acrylates of the present disclosure can be prepared by reacting at least one hydroxy-acrylic with at least one polyisocyanate. Mixtures of hydroxy acrylics and/or mixtures of polyisocyanates can be used. In certain embodiments, the isocyanate to hydroxyl equivalent ratio of the polyisocyanate component to the hydroxy-acrylic component can range from 0.5 to 5, and in certain embodiments from 3 to 4. The molar ratio of reactive isocyanate groups of the polyisocyanate component to the number of reactive hydroxyl groups of the hydroxy-acrylic component, can range from 0.5:10 to 10:0.5. In certain embodiments, urethane acrylates of the present disclosure comprise unreacted hydroxyl groups. Unreacted hydroxyl groups can facilitate adhesion of a coating composition comprising a urethane acrylate to adjoining coatings, by increasing, for example, covalent bonding, hydrogen bonding, and polar interactions with adjoining coatings.

Coating compositions of the present disclosure can further comprise at least one solvent. A solvent can be an aqueous solvent, an organic solvent, or mixtures thereof. Examples of useful organic solvents include aliphatic solvents, aromatic and/or alkylated aromatic solvents such as toluene, xylene, and SOLVESSO 100 (commercially available from ExxonMobil Chemical), alcohols such as isopropanol, acetates such as methoxy propanol acetate, butyl acetate, and isobutyl acetate, esters, ketones, glycol ethers, glycyl ether esters, and mixtures thereof. In certain embodiments, uncured coating compositions of the present disclosure can comprise an amount of solvent ranging from 25 percent to 70 percent by weight, and in certain embodiments, from 35 percent to 55 percent by weight, based on the total weight of the uncured coating composition. In certain embodiments, coating compositions of the present disclosure can have a low level of Volatile Organic Compounds (“VOC”). VOC refers to the amount of organic solvent in a solution and/or dispersion comprising forming a coating composition. For example, in certain embodiments, a coating composition can have a VOC less than 700 g/L, and in certain embodiments, less than 600 g/L.

Coating compositions of the present disclosure can further comprise other materials known in the art of formulating surface coatings, such as pigments, plasticizers, wetting agents, surfactants, flow control agents, catalysts, agents for controlling and/or modifying the rheological properties, thixotropic agents, fillers, anti-gassing agents, mildewcides, fungicides, anti-oxidants, UV light absorbers, organic co-solvents, additional film-forming polymers, polymeric microparticles, catalysts, and other materials generally known for use in organic coating compositions containing film forming resins. In certain embodiments, these and other additives can be present in a coating composition of the present disclosure ranging from 0 weight percent to 40 weight percent, and in certain embodiments from 5 weight percent to 20 weight percent based on the total solids weight of the coating composition.

In certain embodiments, coating compositions of the present disclosure can comprise an amount of rheology modifiers, thixotropic agents and/or flow control agents ranging from 0 percent to 5 percent by weight, and in certain embodiments, ranging from 0 percent 2 percent by weight, based on the total solids weight of the coating composition. Examples of suitable rheology modifiers, thixotropic agents, and/or thixoptropic agents include clays, polyamides, salts of unsaturated polyamine amides, fumed silica, amorphous silica, xanthan gum, and the like.

In certain embodiments, coating compositions of the present disclosure can comprise an amount of wetting agent and/or surfactant ranging from 0 percent to 5 percent by weight, and in certain embodiments, from 1 percent to 3 percent by weight, based on the total solids weight of the coating composition. Examples of suitable wetting agents and/or surfactants include low molecular weight unsaturated polycarboxylic acids, fluorinated compounds, sulfonyls, and the like.

In certain embodiments, coating compositions of the present disclosure can comprise an amount of filler ranging from 0 percent to 20 percent by weight, and in certain embodiments, from 5 percent to 15 percent by weight, based on the total solids weight of the coating composition. Examples of suitable fillers include, hydrophobic fumed silica, calcium carbonate, talc, calcium carbonate, zinc aluminum orthophosphate hydrate, and the like.

Coating compositions of the present disclosure can also include a catalyst to accelerate the cure reaction, for example, the reaction between the reactive hydroxyl groups of the hydroxy-acrylate and the reactive isocyanate groups of the polyisocyanate. In certain embodiments, uncured coating compositions of the present disclosure can comprise an amount of catalyst ranging from 0 percent to 1 percent by weight, and in certain embodiments, from 0 percent to 0.1 percent by weight, based on the total weight of the coating composition. Examples of suitable catalysts include di-butyl tin dilaurate, dibutyl tin oxide, phenol catalysts such as 2,4,6-tridimethylaminomethyl phenol commercially available as DMP-30, and the like. In certain embodiments, a coating composition can include an amine catalyst such as is available under the tradename DESMORAPID, commercially available from Bayer, USA.

In certain embodiments, coating compositions of the present disclosure can comprise an amount of UV stabilizer ranging from 0 percent to 0.1 percent by weight, and in certain embodiments, from 0 percent to 0.02 percent by weight, based on the total solids weight of the coating composition.

In certain embodiments, coating compositions of the present disclosure can comprise an amount of diluent ranging from 0 percent to 0.5 percent by weight, and in certain embodiments, from 0 percent to 0.2 percent by weight, based on the total solids weight of the coating composition. Examples of suitable diluents include glycidyl ethers and/or glycidyl esters, such as glycidyl neodecanoate epoxide resins, and similar compounds commercially available from Shell Chemical Company under the trademark CARDURA E10, and from Exxon Chemical Company under the trademark GLYDEXX-10.

Coating compositions of the present disclosure can comprise one or more dyes and/or pigments to provide color. In certain embodiments, uncured coating compositions of the present disclosure can comprise an amount of dye and/or pigment ranging from 0 percent to 1 percent by weight, and in certain embodiments, from 0 percent to 0.5 percent by weight, based on the total solids weight of the coating composition. Examples of dyes and/or pigments include titanium dioxide, metallic pigments, inorganic pigments, talc, mica, iron oxides, lead oxides, chromium oxides, lead chromate, carbon black, electrically conductive pigments such as conductive carbon black and carbon fibrils, and nanomaterials.

In certain embodiments, coating compositions of the present disclosure can comprise an amount of hydroxy-acrylic ranging from 1 percent to 25 percent by weight, and in certain embodiments, from 5 percent to 15 percent by weight, based on the total solids weight of the coating composition.

In certain embodiments, coating compositions of the present disclosure can comprise an amount of polyisocyanate ranging from 55 percent to 95 percent by weight, and in certain embodiments, from 65 percent to 85 percent by weight, based on the total solids weight of the coating composition.

A coating composition of the present disclosure can be a film-forming composition. “Film-forming” refers to the property that the coating can form a self-supporting continuous film on at least a horizontal surface of a substrate upon curing and solvent removal at ambient or elevated temperature.

In certain embodiments, a urethane acrylate coating composition of the present disclosure can be provided as a three-component system that is mixed prior to application. In a three-component system, the first component can comprise at least one polyisocyanate resin, and at least one solvent. In certain embodiments, the at least one polyisocyanate can include at least one aliphatic polyisocyanate resin such as, for example, TOLONATE HDT 90 (commercially available from Rhodia), at least one cycloaliphatic polyisocyanate resin such as, for example, DESMODUR W (commercially available from Bayer), or mixtures thereof. The use of cycloaliphatic polyisocyanates can enhance the UV resistance of the cured urethane acrylate coating. In certain embodiments, a solvent can comprise butyl acetate, xylene, methoxy propanol acetate, ethoxyethyl propionate, aromatic hydrocarbon solvents, and mixtures thereof. The first component can further comprise additives and/or fillers.

In a three-component system, the second component can comprise at least one hydroxy-acrylic resin, and at least one solvent. Examples of hydroxy-acrylics include, RESINE LTW, MACRYNAL SM 600/60XBAC, and mixtures thereof. In certain embodiments, the solvent can comprise butyl acetate, xylene, methoxy propanol acetate, ethoxyethyl propionate, aromatic hydrocarbon solvents, and mixtures thereof. The second component can further comprise additives and/or fillers.

In a three-component system, the third component can comprise at least one solvent. Examples of solvents include aromatic solvents such as SOLVESSO 100 (ExxonMobil Chemical), xylene, isobutyl acetate, butyl acetate, and mixtures thereof.

In a three-component system, the weight percent of the first, second, and third components used to form a urethane acrylate can be selected based on the stoichiometry of the reactive isocyanate groups of the polyisocyanate and reactive hydroxyl groups of the hydroxy-acrylic. The weight percent of the three components can also be determined by the desired solvent content that can, at least in part, be determined by the method by which the urethane acrylate composition is to be applied.

The amount of solvent in the uncured coating composition of the present disclosure can be an amount sufficient to facilitate the polymerization reaction and application of the coating composition to a surface. Any amount of solvent can be included in a coating composition as appropriate for facilitating polymerization of the polyisocyanate and hydroxy-acrylic components, and to facilitate application of the coating composition to a surface. In certain embodiments, the total amount of solvent in an uncured coating composition of the present disclosure can range from 25 percent by weight to 75 percent by weight, and in certain embodiments, from 35 percent by weight to 55 percent by weight, based on the total (solids and solvent) weight of the coating composition.

In a three-component system, the three components can be thoroughly mixed, and can be applied to a surface within 5 minutes after mixing.

In certain embodiments, a urethane acrylate composition can be provided as a two-component system that is mixed prior to application. In a two-component system, a first component can comprise at least one polyisocyanate resin, and at least one solvent. In certain embodiments, the at least one urethane can include at least one aliphatic polyisocyanate resin such as, for example, TOLONATE HDT 90 at least one cycloaliphatic polyisocyanate resin such as, for example, DESMODUR W or mixtures thereof. The use of cycloaliphatic polyisocyanates can enhance the UV resistance of a urethane acrylate tie coat. In certain embodiments, a solvent can comprise butyl acetate, xylene, methoxy propanol acetate, ethoxyethyl propionate, aromatic hydrocarbon solvents, and mixtures thereof. The first component can further comprise additives and/or fillers.

In a two-component system, the second component can comprise at least one hydroxyl-terminated acrylic resin, and at least one solvent. Examples of hydroxyl-terminated acrylics include, RESINE LTW, MACRYNAL SM 600/60XBAC, and mixtures thereof. The solvent can include aromatic solvents such as SOLVESSO 100 xylene, isobutyl acetate, butyl acetate, and mixtures thereof. The second component can further comprise additives and/or fillers.

In a two-component system, the weight percent of the first and second components used to form a urethane acrylate is selected to maintain the stoichiometry of the polyisocyanate and hydroxy-acrylic components. The weight percent of the two components can also be determined by the desired solvent content that can, at least in part, be determined by the method by which the urethane acrylate composition is to be applied.

Coating compositions of the present disclosure can be used as tie coats to enhance the adhesion of adjoining coatings. In particular, coating compositions of the present disclosure can be used as tie coats to enhance the adhesion between an aged coating and a top coat. An adjoining coating can be a primer coating, a color coating, a top coat, a clear coat, and the like. The adjoining coatings can comprise any coating formulation and/or resin composition in which coating adhesion is enhanced by use of a coating composition of the present disclosure.

In certain embodiments, a coating composition of the present disclosure can be disposed between an underlying coating and an overlying coating. In certain embodiments, the underlying coating can be a primer coating and/or undercoat, and in certain embodiments, the underlying coating can comprise a polyurethane resin. The underlying coating can be an aged coating and can include areas of an aged top coat, areas of an aged undercoat, and/or areas of an aged primer coating. An underlying coating can also include areas in which a coating has not been aged. In certain embodiments, the overlying coating can be a top coat, and the overlying coating can comprise a polyurethane resin.

A coating composition comprising at least one urethane acrylate can be used as a tie coat to provide enhanced adhesion between an aged underlying coating and a top coat. As used herein, tie coat and like terms refer to an intermediate coating intended to facilitate or enhance adhesion between an underlying coating, such as an aged coating, and an overlying top coat. When used as a tie coat, a composition comprising at least one urethane acrylate can be dispersed in an aqueous or non-aqueous solvent. A urethane acrylate composition can comprise any appropriate urethane acrylate, including, for example, any of the urethane acrylates disclosed herein. In certain embodiments, the solvent can be a volatile aprotic organic solvent such as xylene, toluene, dilsobutylacetate, isobutylacetate, methoxypropanol acetate, and the like, and mixtures thereof.

A coating can be treated prior to applying a urethane acrylate tie coat by any method capable of removing particulates and surface films. For example, in certain embodiments, the surface can be solvent wiped using a lint free fabric retaining a volatile solvent such as ethanol, methanol naptha, mineral spirits, methyl isobutyl ketone, methyl ethyl ketone, acetone, or other suitable solvents. In certain embodiments, a commercially available cleaning solvent such as DESOCLEAN 120 (PRC-DeSoto International, Inc.) can be used. It is not necessary to mechanically abrade an aged coating prior to or following application of a urethane acrylate tie coat of the present disclosure to develop adhesion.

A urethane acrylate containing tie coat can be applied by any appropriate method depending at least in part on the solvent and weight percent of the urethane acrylate containing tie coat dispersion. For example, a urethane acrylate containing tie coat can be applied by brushing, spraying, dipping, rolling, flowing, and the like. Spraying methods include compressed air spray and electrostatic spray, and include manual and automatic methods. In certain embodiments, a tie coat can be applied by wiping a surface with a material, for example a cloth, soaked in a tie coat composition. The low VOC content of the urethane acrylate tie coat compositions of the present disclosure, make the compositions particularly useful for spray coating.

A urethane acrylate tie coat can be applied to a surface to any appropriate dry film thickness to provide adhesion between the underlying and overlying coatings. In certain embodiments, the dry film thickness of a urethane acrylate tie coat can range from 0.05 mils to 1 mil, and in certain embodiments, can range from 0.2 mils to 0.8 mils.

In certain embodiments, more than one coating of a urethane acrylate containing tie coat can be applied to a coating. The more than one tie coat layer can be applied from a composition having the same or different weight percent of urethane acrylates, and/or can comprise a different urethane acrylate as other tie coat layers. A subsequent urethane acrylate tie coat can be applied to a previously applied tie coat after a period of time sufficient for the previously applied tie coat to develop self-adhesive properties. Multiple urethane acrylate tie coats can generally self-adhere when a previously applied urethane acrylate coating is tacky. In certain embodiments, a second urethane acrylate coating can be applied to a first urethane acrylate coating ranging from 15 minutes to 5 hours following application of the first coating.

Following application of a urethane acrylate tie coat to a coating, the tie coat can be dried. The tie coat can be dried for a period of time sufficient to evaporate the solvent and for the tie coat to develop adequate adhesion characteristics. The time to dry a particular tie coat can depend, at least in part, on the amount of solvent applied, the thickness of the tie coat, the vapor pressure of the solvent,. the temperature and humidity, and the airflow at the surface. In certain embodiments, a tie coat can develop adequate adhesion characteristics when a top coat applied over the tie coat passes a dry adhesion test. For example, a tie coat develops adequate adhesion when a top coat applied over the tie coat passes the parallel 45-degree scribe test according to BSS 7225 specification, after the top coat has been cured from 1 hour at room temperature. In certain embodiments, a tie coat of the present disclosure is dry when tack free. As used herein, “tack free” refers to the property that the coating composition is no longer sticky to the touch. In certain embodiments, a coating composition of the present disclosure is dry within 15 minutes following application.

In certain embodiments, a urethane acrylate tie coat can be dried for a time ranging from 15 minutes to 24 hours or longer before an overlying coating is applied. In certain embodiments, a top coat can be applied to the tie coat within 48 hours after the tie coat is applied.

After the urethane acrylate tie coat is tack free and has developed adequate adhesion characteristics, one or more top coats including, for example, any of those disclosed herein, can be applied to the tie coat. A top coat can be applied to the tie coat using any appropriate coating method as disclosed herein. Each of the one or more top coats can be applied to any appropriate dry film thickness. For example, in certain embodiments the dry film thickness of a polyurethane top coat can range from 0.25 mils to 5 mils, in certain embodiments from 0.5 mils to 4 mils, and in certain embodiments from 0.5 mils to 2 mils. A top coat can be cured according to recommended procedures, including at ambient temperature.

In certain embodiments, a top coat composition can comprise a curable polyurethane coating composition. It can be useful that top coats used to finish and refinish certain surfaces, such as surfaces on aviation and aerospace vehicles, exhibit hardness, resistance to water and solvents, be easy to apply, and/or result in films having high gloss. Coating compositions comprising a hydroxyl-functional polymer such as a polyester or acrylic polymer and a polyisocyanate can be used for these applications. Two-component polyurethane coating compositions can comprise an organic polyisocyanate in one component, sometimes referred to herein as the “isocyanate component,” and a hydroxyl-containing polymer such as a polyester polyol, a polyether polyol or hydroxyl-containing acrylic polymer in a second component. This second component is sometimes referred to herein as the “polyol component.” The two components are maintained separate until immediately prior to application. After application, the polyisocyanate and polymeric polyol react to form a cured polyurethane coating. The reaction between the hydroxyl-functional polymer and the polyisocyanate can occur at room temperature, and catalysts can be added to speed the reaction. Other constituents such as pigments, solvents, catalysts, additives, and the like can be formulated into either of the two components. Two-component polyurethane coatings and adhesives are known (see U.S. Pat. No. 4,341,689, for example) and are commercially available. An example of a commercially available two-component polyurethane coating composition is DESOTHANE CA 2000 (PRC-DeSoto International, Inc., Burbank, Calif.).

Single-component moisture curing polyurethane compositions can also be used to produce high quality coatings. Moisture curing polyurethane polymers can be prepared by reacting a stoichiometric excess of an organic polyisocyanate with a polymeric polyol, such as a polyester polyol, a polyether polyol or a hydroxyl-containing acrylic polymer to form a polyisocyanate polymer. The polyisocyanate polymer can be formulated with solvents, pigments, additives, and the like to form the coating composition. An example of a commercially available moisture-cured polyurethane coating is DESMODUR E polyisocyanate (Bayer Corporation, Pittsburgh, Pa.).

Two-component and single-component polyurethane coating compositions can be provided as either an aqueous-based or organic solvent-based formulation. In certain embodiments, the organic solvent can be an aliphatic or aromatic hydrocarbon such as toluene or xylene, an alcohol such as butanol or isopropanol, an ester such as butyl acetate or ethyl acetate, a ketone such as acetone, methyl isobutyl ketone, or methyl ethyl ketone, an ether, an ether-alcohol, or ether-ester, or a mixture of any of the foregoing. A polyurethane coating composition can comprise a single type of polyurethane polymer, or can comprise a mixture of different types of polyurethane polymers.

Adhesion of a coating system comprising at least one polyurethane top coat and at least one urethane acrylate tie coat can be determined by any appropriate method. For example, adhesion can be determined using the Dry Adhesion Test, 7-Day Wet Adhesion Test, and/or 36-Day Wet Adhesion Test according to BSS 7225 (Boeing Specification Support Standard). The Whirling Arm Rain Erosion Resistance Test (BSS 7225)can also be used to evaluate the adhesion characteristics of the coatings. The solvent resistance of a coating system can be determined using, for example, Skydrol solvent resistance test (BMS3-11). The foregoing test methods are described herein.

### EXAMPLES

Embodiments of the present disclosure can be further defined by reference to the following examples, which describe in detail preparation of compound of the present disclosure and assays fro using compound of the present disclosure. It will be apparent to those skilled in the art that many modifications, both to materials and methods, may be practiced without departing from the scope of the present disclosure.

### Adhesion Tests

The adhesion of the coatings, interlayers, and top coats disclosed herein were evaluated using dry adhesion, wet adhesion, and whirling arm rain erosion resistance test methods.

The adhesion of polyurethane coatings disclosed herein was evaluated using the procedures described in BSS 7225 (Boeing Specification Support Standard). In the Dry Adhesion Test (Type I) test, specimens were scribed with a stylus, for example, to produce two parallel scribes separated by 1 inch, and a single scribe intersecting the parallel scribes at an angle of 45±5 degrees (BSS 7225, Parallel Plus 45 Degree Scribes—Class 3). A 1-inch wide masking tape having rubber or acrylic adhesive with a minimum peel strength of 60 oz/inch width when tested in accordance with ASTM D 330, Method A, was pressed onto the surface of the scribed test specimen perpendicular to the parallel scribes and covering the 45 degree scribe in the region between the parallel scribes. In a single abrupt motion, the tape was pulled perpendicular to the test specimen. The tested area and the tape were then examined for any removed coating. A coating that passed the adhesion test exhibited no, or very slight, loss of coating beyond the scribes, as indicated by classifications 10 and 9, respectively, in BSS 7225. Classification 10 corresponds to no loss of paint along the scribes, and classification 9 corresponds to very slight loss of paint beyond the scribes. Adhesion failure was indicated for results corresponding to classifications 8 through 1 as defined in BSS 7225.

The wet adhesion of the interlayer and top coats was evaluated using the procedure described in BSS 7225, Wet Adhesion, Immersion Method (Type III). Test specimens were immersed in distilled water for either 7 days or 36 days. At the end of the specified time, the test specimens were removed from the water, wiped dry, and the adhesion of the coating evaluated as described for the dry adhesion test.

The adhesion of the interlayers and top coats was also evaluated using the Whirling Arm Rain Erosion Resistance Test. Aluminum 2024-T3 test panels in the shape of a curved foil with dimensions of 3 inches×6 inches×0.032 inches were pretreated with a chromate conversion coating according to MIL-C-5541 Class1A. Test panels were then solvent wiped and dried prior to application of coatings. After the coatings were applied and dried, the test panels were immersed in water at 25° C. for 16 to 24 hours prior to testing. Within one hour after removal from the water, the test panels were secured to a whirling arm fixture. The specimens were then exposed to 385 mile per hour, 3 to 4 inch per hour water spray, characterized by a 1 to 4 mm drop size, for 30 minutes. Failure was indicated when any coating peeled more than 0.25 inches from the leading edge of the test panel.

### Skydrol Solvent Resistance Test

The Skydrol Solvent Resistance Test is performed by immersing a test panel having a coating system in Skydrol jet aviation fuel for a minimum of 30 days at 70° C. The test panel having a coating system is removed, and dried. The pencil hardness of the coating system is then measured. A coating system passes the Skydrol Solvent Resistance Test when the pencil hardness is at least “H”.

### Example 1

A three-component urethane acrylate tie coat composition was prepared by combining Component A comprising at least one polyisocyanate, Compound B comprising at least one hydroxy acrylic, and Component C comprising solvents.

Component A was prepared by combining 0.1 weight percent pigment, 66.5 weight percent polyisocyanate, and 33.4 weight percent solvent, where weight percent is based on the total weight of Component A.

Component B was prepared by combining 0.41 weight percent rheology modifiers, 5.3 weight percent wetting agents, 32 weight percent filler, 0.08 weight percent catalyst, 0.22 weight percent diluent, 0.06 weight percent UV stabilizer, 28 weight percent acrylic, and 34 weight percent organic solvents, where the weight percent is based on the total weight of Component B.

Component C was prepared by combining organic solvents.

Components A, B, and C exhibit a shelf life stability in excess of 1 year.

### Example 2

Aluminum 2024-T3 test panels were first coated with a CA 8000 polyurethane coating (commercially available from PRC-DeSoto International, Inc.) and cured at 120° F. for at least 6 hours. The polyurethane coatings were then treated using a methylethyl ketone (MEK) or DESOCLEAN 120 (commercially available from PRC-DeSoto International) solvent wipe. Tie coat compositions were prepared by combining Component A, Component B, and Component C prepared in Example 1, in a ratio of 3:1:1 parts by weight, respectively. When mixed, the tie coat composition has a 48% by weight solids content, a VOC of 500 g/L, and exhibits a useful pot life of up to about 4 hours. Components A, B, and C were thoroughly mixed and after about 5 minutes, were ready to be spray coated. The tie coat was spray coated onto the cured polyurethane coating to a dried film thickness of about 0.5 mils. The matte finish of the applied tie coat layer facilitated distinguishing between regions to which the tie coat layer had been applied, and regions that were uncoated. The tie coats were then allowed to set at 25° C. for times ranging from 15 minutes to more than 24 hours. The urethane acrylate tie coats were tack free after about 15 minutes at 25° C. After the tie coats were set until tack free, a CA 8000 polyurethane top coat was applied to produce a top coat having a dry film thickness of 0.5 mils to 4 mils.

The coating systems comprising the CA 8000 polyurethane primer coating, the urethane acrylate tie coat, and the CA 8000 polyurethane top coat, passed dry adhesion, wet adhesion, whirling arm rain erosion resistance, and Skydrol solvent resistance tests as described herein.

### Example 3

Test panels having a coating system of a CA 8000 polyurethane undercoat, a urethane acrylate tie coat, and a CA 8000 polyurethane top coat were prepared as described in Example 2. The coating systems were aged at ambient temperature and humidity for 18 months, or thermally aged for 14 days at a temperature of 140° F. The aged coatings were treated and the tie coat and polyurethane top coats applies as described in Example 2. The aged coating systems passed the whirling arm test. The aged coating systems also passed the Skydrol solvent resistance test.

### Example 4

The self adhesion of a urethane acrylate tie coat was evaluated by applying a urethane acrylate tie coat layer to a test panel comprising a CA8000 polyurethane coating, as described in Example 2. After 15 minutes the urethane acrylate tie coat layer was tack free. At various time intervals from 15 minutes through 5 hours following application of the first tie coat layer, a second 0.5 mil thick layer of a urethane acrylate tie coat layer was applied to the first tie coat layer. After the second tie coat layer was adequately dried, a CA 8000 polyurethane top coat was spray coated over the second tie coat layer. When the second tie coat layer was applied from 15 minutes to 5 hours following application of the first tie coat layer, the coating system passed the dry adhesion, wet adhesion, whirling arm rain erosion resistance, and Skydrol solvent resistance tests as described herein.

Other embodiments of the present disclosure will be apparent to those skilled in the art from consideration of the specification and practice of the present disclosure. It is intended that the specification and examples be considered as exemplary only, with a true scope and spirit of the present disclosure being indicated by the following claims.

What is claimed is:

1. A coating composition comprising at least one urethane acrylate wherein the at least one urethane acrylate comprises:
at least one curable polyisocyanate comprising reactive isocyanate groups; and
at least one hydroxy acrylic comprising reactive hydroxyl groups,
wherein the urethane acrylate comprises unreacted hydroxyl groups.

2. The coating composition of claim 1, wherein the ratio of isocyanate groups to hydroxyl groups ranges from 0.5 to 10.

3. The coating composition of claim 1, wherein the ratio of isocyanate groups to hydroxyl groups ranges from 3 to 4.

4. The coating composition of claim 1, wherein the coating composition further comprises at least one of the following: at least one additive, and at least one filler.

5. A method of enhancing adhesion between a first coating and a second coating comprising:
applying a tie coat comprising at least one urethane acrylate to the first coating;
setting the tie coat until tack free; and
applying the second coating to the tie coat,
wherein the adhesion between the first coating and the second coating is enhanced compared to the adhesion between the same first coating and the same second coating without the tie coat.

6. The method of claim 5, wherein the at least one urethane acrylate is formed by reacting:
at least one curable polyisocyanate comprising reactive isocyanate groups; and
at least one hydroxy acrylic comprising reactive hydroxyl groups,
wherein the urethane acrylate comprises unreacted hydroxyl groups.

7. The method of claim 5, wherein the cured coatings pass the whirling arm rain erosion resistance test according to BSS 7225 specification.

8. The method of claim 5, wherein the cured coatings pass the whirling arm rain erosion resistance test according to BSS 7225 specification, dry adhesion test, wet adhesion test, impact resistance test, and hot Skydrol resistance test.

9. The method of claim 5, wherein the first coating comprises an aged coating.

10. The method of claim 5, wherein the second coating comprises a polyurethane top coat.

11. A multi-layer coating comprising:
a first coating;
a second coating; and
a tie coat comprising at least one urethane acrylate disposed between the first and second coating.

12. The method of claim 11, wherein the at least one urethane acrylate is formed by reacting:
at least one curable polyisocyanate comprising reactive isocyanate groups; and
at least one hydroxy-acrylic comprising reactive hydroxyl groups,
wherein the urethane acrylate comprises unreacted hydroxyl groups.

13. The multi-layer coating of claim 11, wherein the dry film thickness of the tie coat ranges from 0.05 mils to 1 mil.

14. The multi-layer coating of claim 11, wherein the dry film thickness of the tie coat ranges from 0.2 mils to 0.8 mils.

15. The multi-layer coating of claim 11, wherein the tie coat provides enhanced adhesion between the first coating and the second coating compared to adhesion between the same first coating and same second coating without the tie coat.

16. The multi-layer coating of claim 11, wherein the first coating comprises an aged coating.

17. The multi-layer coating of claim 11, wherein the second coating comprises a polyurethane top coat.

18. The multi-layer coating of claim 11, wherein the multi-layer composite coating passes the whirling arm rain erosion resistance test according to BSS 7225 specification.

19. The multi-layer coating of claim 11, wherein the multi-layer composite coating passes the whirling arm rain erosion resistance test according to BSS 7225 specification, dry adhesion test, wet adhesion test, impact resistance test, and hot Skydrol resistance test.

20. A method of refinishing an aged coating comprising:
applying a tie coat comprising at least one urethane acrylate to the aged coating;
setting the tie coat until tack free;
applying a curable polyurethane top coat to the tie coat; and
curing the curable polyurethane top coat.

21. The method of claim 20, wherein the at least one urethane acrylate is formed by reacting:
at least one curable polyisocyanate comprising reactive isocyanate groups; and
at least one hydroxy-acrylic comprising reactive hydroxyl groups,
wherein the urethane acrylate comprises unreacted hydroxyl groups.

22. The method of claim 20, wherein the tie coat is applied from a solution having a volatile organic content less than 700 g/L.

23. The method of claim 20, wherein the aged coating is not mechanically abraded prior to application of the tie coat.

24. The method of claim 20, wherein the tie coat provides enhanced adhesion between the aged coating and the polyurethane top coat compared to the adhesion between the same aged coating and the same polyurethane top coat without the tie coat.

25. The method of claim 20, wherein the refinished coating passes the whirling arm rain erosion resistance test according to BSS 7225 specification.

26. The method of claim 20, wherein the refinished coating passes the whirling arm rain erosion resistance test according to BSS 7225 specification, dry adhesion test, wet adhesion test, impact resistance test, and hot Skydrol resistance test.

27. The method of claim 20, wherein the aged coating is on a surface of an aviation or aerospace vehicle.

28. The method of claim 20, wherein the dry film thickness of the tie coat ranges from 0.05 mils to 1 mil.

29. The method of claim 20, wherein the dry film thickness of the tie coat ranges from 0.2 mils to 0.8 mils.

30. The method of claim 20, wherein the aged coating comprises an aged polyurethane coating.
